(19) United States
(12) Patent Application Publication
(10) Pub. No.: US 2026/0346886 A1
(43) Pub. Date: Nov. 5, 2026

(54) CLOSING DELAY SYSTEM FOR A SPRING-ACTION RAIL CLAMP HAVING AN ELECTRIC MOTOR

(71) Applicant: DELLNER BUBENZER Germany GmbH, Kirchen-Wehbach (DE)

(72) Inventor: Daniele MONTICELLI, San Vittore Olona (IT)

(73) Assignee: DELLNER BUBENZER Germany GmbH, Kirchen-Wehbach (DE)

(21) Appl. No.: 19/708,318

(22) Filed: Jun. 15, 2026

Related U.S. Application Data
(63) Continuation of application No. PCT/EP2024/085674, filed on Dec. 11, 2024.

(30) Foreign Application Priority Data
Dec. 14, 2023 (DE) 10 2023 135 259.8

(51) Int. Cl. B61H 7/12; B60T 13/22; B60T 13/74; B60T 17/02; B61H 13/00

(52) U.S. Cl. CPC B61H 7/12; B60T 13/22; B60T 13/745; B60T 17/02; B61H 13/005

(57) ABSTRACT

A closing delay system for a spring-action rail clamp having an electric motor, in particular as a storm brake of a cargo handler. A tank has a damping fluid and a pump is driveable by the electric motor in order to convey the damping fluid bidirectionally. A check valve is arranged in a line section through which the damping fluid flows. A throttle is arranged, in parallel with respect to the check valve, in the line section through which a flow is caused to pass by the pump, such that the conveyed damping fluid is subjected to an increased flow resistance in a conveying direction through the line section equipped with the throttle, such that a time of engagement of the spring-action rail clamp is delayed.

This nonprovisional application is a continuation of International Application No. PCT/EP 2024/085674, which was filed on Dec. 11, 2024, and which claims priority to German Patent Application No. 10 2023 135 259.8, which was filed in Germany on Dec. 14, 2023, and which are both herein incorporated by reference.

### BACKGROUND OF THE INVENTION

### Field of the Invention

The present invention relates generally and in particular to a closing delay system for a spring-action rail clamp having an electric motor, to a spring-action rail clamp having an electric motor, to a control device, and to a cargo handler.

### Description of the Background Art

Rail clamps for a cargo handler are generally known. It is the object of the rail clamp to prevent uncontrolled movement of the cargo handlers under the action of wind. This type of rail clamp is designed such that the cargo handler can be secured at any position along the track.

Rail clamps are, as standard, hydraulically released (opened) by a cylinder and fixed (closed) by installed compression springs. The braking action is achieved by means of suitable brake pads that press against both sides of the upper part of the rail. Here, the hydraulic cylinder is operated by a hydraulic assembly.

Owing to growing market demand, an electrically operated spring-action rail clamp without a hydraulic assembly is being developed. The functional principle is the same as that of the standard rail clamp: The spring force closes the rail clamp.

The main difference is in that the spring-action rail clamp is opened by an electric motor and a reversible transmission, and not by a hydraulic assembly.

### SUMMARY OF THE INVENTION

It is therefore an object of the present invention to provide a closing delay system for a spring-action rail clamp having an electric motor.

According to a first aspect, the present invention provides a closing delay system for a spring-action rail clamp having an electric motor. According to a second aspect, the present invention provides a spring-action rail clamp having an electric motor. According to a third aspect, the present invention provides a control device. According to a fourth aspect, the present invention provides a cargo handler.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an example of a closing delay system;

FIG. 2 shows a hydraulic diagram of an example of a closing delay system;

FIG. 3 shows an example of a spring-action rail clamp having a closing delay system;

FIG. 4 shows an example of a cargo handler;

FIG. 5 shows a flow diagram of the disengagement process of the spring-action rail clamp; and

FIG. 6 shows a flow diagram of the closing process of the spring-action rail clamp.

### DETAILED DESCRIPTION

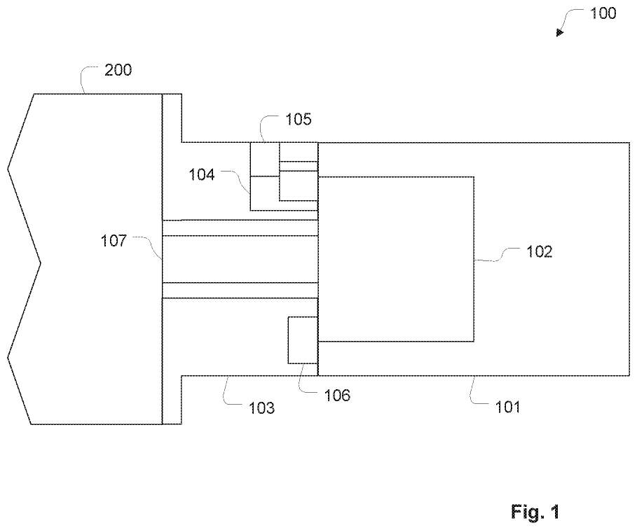

FIG. 1 illustrates an example corresponding to the present invention. General explanations of the examples will firstly be given below, before a more detailed description is given.

The invention relates to a closing delay system for a spring-action rail clamp having an electric motor, in particular as a storm brake of a cargo handler, comprising: a tank having a damping fluid, a pump that is driveable by the electric motor in order to convey the damping fluid bidirectionally, a check valve that is arranged in a line section through which the damping fluid flows, and a throttle that is arranged, in parallel with respect to the check valve, in the line section through which a flow is caused to pass by the pump, such that the conveyed damping fluid is subjected to an increased flow resistance in a conveying direction through the line section equipped with the throttle, such that a time of engagement of the spring-action rail clamp is delayed.

The damping fluid can be, for example, an oil of a specified viscosity. The viscosity of the damping fluid gives rise to viscous friction in the damping fluid in the flow through the throttle. The viscous friction dissipates the energy of the rotation that drives the pump, and generates an increased flow resistance for the damping fluid. It will be described further below that a spring force of the spring-action rail clamp can rotate the rotor of the electric motor. It is the intention for this rotation to be slowed by the closing delay system.

The pump conveys the damping fluid in the line section through which flow passes.

The pump can be a pump which is mechanically connected to a shaft of the electric motor and which can convey the oil in a forward direction and optionally also in a backward direction. The bidirectional conveyance may also be implemented using additional valves by means of which a pump, which has one preferential conveying direction, is connected to the line section differently in order to implement the two conveying directions in the line section.

The electric motor is mechanically coupled to the pump and drives said pump when the rotor of the electric motor rotates. Owing to the increased flow resistance in one conveying direction, the electric motor is subjected to a resistance in one direction of rotation. This also occurs if the rotor of the electric motor is rotated in this direction of rotation by forces external to the electric motor.

The pump can be arranged within the tank.

It is thus possible to construct a sealed closing delay system, in which all components through which the damping fluid flows are situated within the tank. The entire system is integrated into one single, maintenance-free component, which is connected directly to the electric motor. This results in a sealed component.

The pump can comprise a gear pump.

The pump can convey the damping fluid from the tank through the line section and back into the tank when the electric motor drives the pump.

The closed circuit is necessary to provide a sealed closing delay system, in which all components through which the damping fluid flows are situated within the tank.

If the shaft of the electric motor is rotated, the pump is driven owing to the mechanical coupling of the pump to the shaft.

The tank can have a tank casing and a flange.

The flange and the tank casing form the closed-off space of the tank, wherein the flange is used for the installation of the closing delay system on the spring-action rail clamp, in particular for installation on the electric motor or on an electromagnetic brake.

The pump can be installed on the flange of the tank.

The line section through which flow passes can be formed in the flange.

This, too, assists in constructing a sealed closing delay system, in which all components through which the damping fluid flows are situated within the tank.

The invention also relates to a spring-action rail clamp having an electric motor, furthermore comprising: the closing delay system as discussed above, which is driveable by the electric motor.

The spring-action rail clamp may comprise a rail-clamping device which is designed to laterally clamp a rail when in a closed position. A spring device provides a spring force which is exerted on the rail-clamping device and which, in the absence of an opposing force, moves the rail-clamping device into, or holds said rail-clamping device in, a closed position.

A combination of an electric motor and an electromagnetic brake may be mechanically coupled to one another. The electric motor may be used to generate the force that opposes the spring force, for example via a ball screw drive. The shaft of the electric motor can be fixed by means of the electromagnetic brake. The electric motor can thus be deactivated when an opened position (disengagement position) of the rail-clamping device has been reached. This is particularly important if, in the opened position of the rail-clamping device, the spring force still exerts a torque on the shaft or on the rotor of the electric motor, for example via the ball-screw drive.

A ball screw drive that is rotated by the electric motor exerts a force on the spring device counter to the spring force. Here, the rail-clamping device is moved from the closed position into a disengagement position.

When the spring-action rail clamp is in a deenergized state, the rail-clamping device is held in the closed position by the spring device, and when said spring-action rail clamp is in an energized state, the rail-clamping device is moved into a disengagement position by the electric motor and the screw. The rail-clamping device is held in the disengagement position by means of the electromagnetic brake.

During the movement from the disengagement position into the closed position, the rotation of the electric motor is subjected to a resistance by the closing delay system, such that said movement is slowed. This is the case in particular if the electric motor is rotated by the spring force and screw.

If the rail clamp is used in cargo handler, it is important that, in the event of a failure of the electrical power supply, the rail clamp engages after a delay. This delay is necessary in order that the cargo handler can be stopped by the drives/service brakes before the rail clamp engages. The absence of the delay can lead to serious safety problems, because the rail clamp is an immobilizing brake (static) and is not designed for dynamic applications.

Such a spring-action rail clamp is an electrical solution, in which a delay is implemented by means of a maintenance-free, sealed closing delay system.

When the spring-action rail clamp is opened (disengaged), the electric motor is rotated in one direction. In the process, the pump conveys the damping fluid through the check valve and back into the tank.

When the spring-action rail clamp is closed, the supply of electrical power to the electric/magnetic brake is interrupted, and the rail clamp thus begins to close under the action of the spring force. In the process, the transmission is moved backward by the force of the springs, and the electric motor and the pump rotate in the opposite direction (in relation to the opening process). The pump thus conveys the damping fluid in the opposite direction, whereby the check valve is closed, and flow passes substantially through the throttle. During the closing phase, the acting force arising from the spring force is reduced by an opposing force arising from the energy dissipated by the throttle, giving rise to the closing delay.

The invention also relates to a control device for controlling a spring-action rail clamp having an electric motor as discussed above.

The invention also relates to a cargo handler having at least one of the following: a control device as discussed above, a spring-action rail clamp having an electric motor as discussed above, and a closing delay system as discussed above.

Returning to FIG. 1, this figure shows an example of a closing delay system.

In the event of an electrical failure, the spring-action rail clamp must engage after a delay. This delay is necessary in order that the cargo handler can be stopped by the drives/service brakes before the spring-action rail clamp engages. The absence of the delay can lead to serious safety problems, because the spring-action rail clamp is an immobilizing brake (static) and is not designed for dynamic applications.

The closing delay system 100 comprises a tank casing 101, a pump 102, a flange 103, a line section 104, a valve device 105, a further line section 106, a shaft 107 and an electric drive unit 200.

The tank casing 101 and the flange 103 together form the tank. The tank contains a damping fluid. The damping fluid is for example a viscous oil.

The pump 102 is arranged within the tank and is installed on the flange 103. The inlet and outlet openings of the pump 102 are connected to the line section 104 and to the further line section 105. The pump is mechanically coupled to the shaft 107. The shaft 107 is also coupled to the electric drive unit 200. The pump can thus be driven by an electric motor in the electric drive unit 200. The pump 102 may for example comprise a gear pump.

A valve device 105 is arranged in the line section 104, which valve device can regulate the flow resistance to which the flow of the damping fluid is subjected. The flow resistance acts, in turn, on the pump 102, giving rise to a resistance to rotation at the pump.

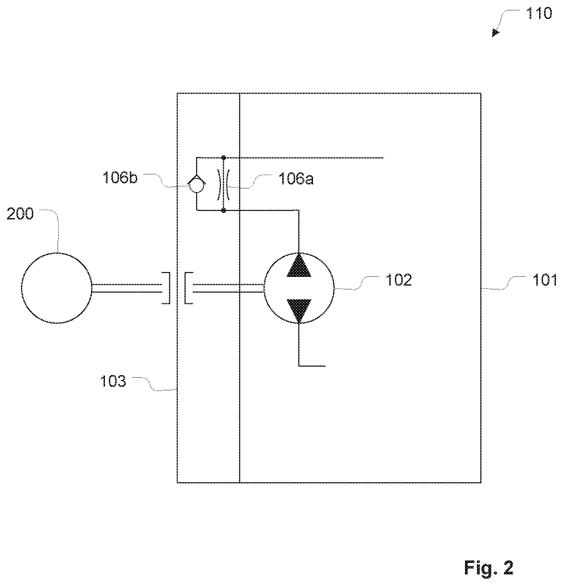

FIG. 2 shows a hydraulic diagram of an example of a closing delay system.

The hydraulic diagram 110 shows a tank casing 101 and a flange 103, which form the tank, and also shows a pump 102, an electric drive unit 200, a throttle 106a, and a check valve 106b.

The pump 102 conveys the damping fluid bidirectionally. The check valve 106b opens in one of the conveying directions of the pump 102 and closes in the other conveying direction. The opening of the check valve 106b causes the damping fluid to flow with relatively little flow resistance through the check valve 106b.

When, in the case of the other conveying direction, the check valve 106b is closed, then the damping fluid conveyed by the pump can flow only through the throttle 106a. When flow passes through the throttle 106a, an increased flow resistance is generated owing to the viscous friction of the damping fluid.

The pump 102 from FIGS. 1 and 2 conveys the damping fluid bidirectionally. This can be effected by virtue of the pump 102 comprising a pump that conveys in both conveying directions with approximately equal efficiency. Such a pump is for example a gear pump. The different conveying directions are generated here by the different directions of rotation of the shaft (107 in FIG. 1).

Furthermore, the pump may also have a preferential conveying direction, with the delay system being designed such that the check valve closes if the damping fluid is conveyed in the preferential conveying direction of the pump.

An increased flow resistance is thus generated by the valve device (106 in FIG. 1). The valve device (106 in FIG. 1) can be formed of a throttle 106a and a check valve 106b. In any case, the damping fluid is conveyed from the tank through the pump and the line sections and back into the tank.

When the spring-action rail clamp is opened (disengaged), the electric motor and the pump rotate in one direction, and the damping fluid flows through the check valve in the resulting conveying direction of the pump.

In the deenergized state, the spring-action rail clamp begins to close. The electric motor and the pump rotate in the opposite direction, because the transmission moves backward owing to the force of the springs. The damping fluid flows through the throttle because, in the flow direction that then prevails, the check valve is closed.

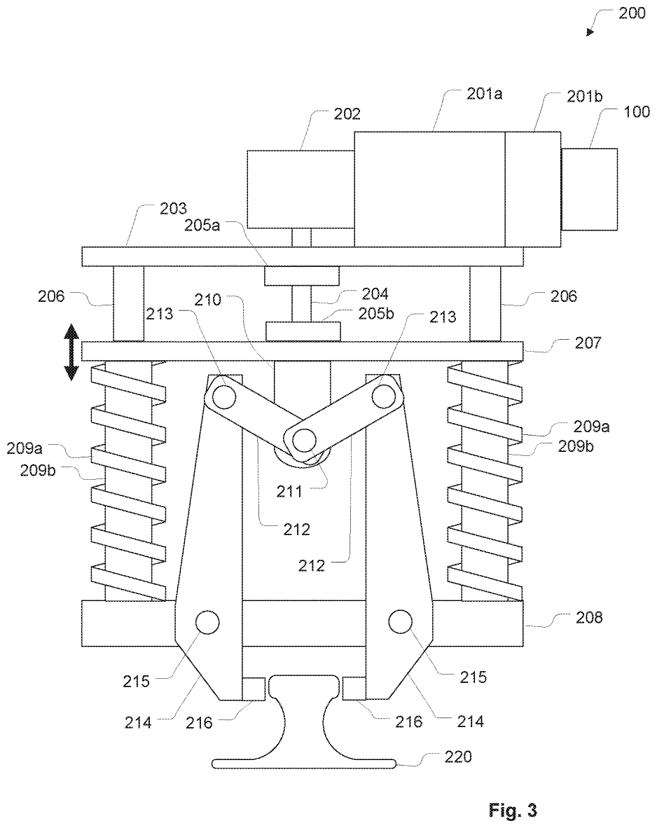

FIG. 3 shows an example of a spring-action rail clamp having a closing delay system.

The spring-action rail clamp 200 comprises a closing delay system 100, an electric motor 201a, an electromagnetic brake 201b, a transmission 202, a first yoke 203, a spindle 204, a bearing 205a, a spindle nut 205b, a support 206, a second yoke 207, a third yoke 208, a spring 209a, a translational guide element 209b, a holder 210, rotational guide elements 211, 213 and 215, a lever 212, a clamping jaw 214, and a brake pad 216.

The closing delay system 100, the electromagnetic brake 201b, the electric motor 201a and the transmission 202 form the disengagement unit of the spring-action rail clamp 200. In one direction of rotation, the electric motor opens, that is to say disengages, the spring-action rail clamp 200. In the other direction of rotation, the spring-action rail clamp 200 closes, clamps the rail 220, and thus fixes the position of the spring-action rail clamp 200 relative to the rail. The spring-action rail clamp 200 is connected to at least one assembly of a cargo handler (and thus also fixes the position of the assembly of a cargo handler relative to the rail.

The disengagement unit is fixed to a first yoke 203 and drives a spindle 204 of a ball screw drive, whereby the spacing between the bearing 205a and a spindle nut 205b is varied. The bearing 205a is connected to the first yoke 203, receives a force from the spindle 204, and transmits said force to the first yoke 203.

The spindle nut 205b is connected to the second yoke 207 and is movable upward or downward along the spindle 204 as a result of rotation of the spindle 204. The spindle nut 205b also receives a force from the spindle 204, and transmits said force to the yoke 207. Here, it is possible both for the spindle nut 205b to be moved by a torque on the spindle 204 and for the spindle 204 to be rotated by a translational force on the spindle nut 205b.

The third yoke 208 is connected via a support 206 to the first yoke 203. The second yoke 207 moves along the translational guide elements 209b. If the second yoke 207 moves downward along the translational guide elements 209b, the springs 209a are compressed.

In this illustration, the support 206 is either arranged behind the translational guide element 209b or runs within a cavity of the translational guide element 209b. The support 206 may however be provided in any desired arrangement. In particular, four springs 209a may be used, and two supports 206 may be arranged between in each case two springs 209a.

The rotation of the spindle 204 thus causes the disengagement unit to move the second yoke 207 downward, counter to the spring force of the springs 209a between the two yokes 203 and 208. The yokes 203 and 208 are fixedly spaced apart by the supports 206.

The holder 210 is connected to the second yoke 207 and holds the rotational guide element 211. The rotational guide element 211 thus moves up and down together with the second yoke 207.

The rotational guide element 211 is connected to the levers 212, which in turn are connected by means of the rotational guide elements 213 to the clamping jaws 214.

If the second yoke 207 and thus also the rotational guide element 211 are moved upward, the levers 212 rotate about the rotational guide element 213 and approach a horizontal position. In the process, the rotational guide elements 213 are pushed apart, and the clamping jaws 214 rotate about the rotational guide elements 215.

In the case of such a movement, the brake pads 216 are then pressed by the clamping jaws 214 against the sides of the rail 220. This movement is performed if the springs 209a move the second yoke 207 and thus the rotational guide element 211 upward, which is also possible in a deenergized state of the spring-action rail clamp. During this upward movement of the second yoke 207, the spindle 204 is rotated by the spindle nut 205b. This rotation is transmitted by the transmission 202, the electric motor 201a and the electromagnetic brake 201b to the closing delay system 100.

In the closing delay system 100, the rotation of the rotor of the electric motor 201a causes the pump to be driven, such that the flow of the damping fluid is subject to a flow resistance. This means that the rotation of the spindle 204, the upward movement of the second yoke 207 and ultimately the closure of the clamping jaws 214 are subjected to a resistance, which delays the closing and thus the time of engagement of the spring-action rail clamp 200.

To open or disengage the clamping jaws 214 or the spring-action rail clamp 200, the electric motor 201a rotates the spindle 204 and the pump in the closing delay system 100 in the other direction of rotation, with the closing delay system 100 preferably not generating any resistance to the rotation. The spindle 204, the bearing 205a and the spindle nut 205b exert a force on the spindle 204 as a result of the rotation, which force pushes the yoke 207 away from the yoke 203 and thus compresses the springs 209a. In the opened position, the spring-action rail clamp 200 is fixed by the electromagnetic brake, and the electric motor is deactivated.

At least the opened position of the spring-action rail clamp 200 can be checked by means of limit switches. The electric motor 201a then opens the spring-action rail clamp 200 to such an extent that a signal from a limit switch changes. Said limit switch may for example be installed such that the second yoke 207 moves against the limit switch in a lower position. The electric motor 201a is then deactivated, and the electromagnetic brake 201b is activated. A second limit switch may be installed as a redundancy and failure monitoring means, if a movement takes place beyond the first limit switch.

It is also possible for a limit switch to be installed which outputs a signal indicating a movement of the spring-action rail clamp 200 from the opened position into the closed position, for example in order to initiate an emergency stop if the closure is not intended. This safety switch may be arranged above the limit switch for the opened position of the spring-action rail clamp 200.

It is also possible, by using multiple limit switches, to determine a time difference between the signals in order to diagnose the function of the spring-action rail clamp 200 and possibly perform an emergency stop and a deactivation of the electric motor if said time value overshoots or undershoots limit values. Overloading of the individual components can thus be prevented.

The spring-action rail clamp 200 is closed under at least one of the following conditions: if the supply voltage is interrupted or fails, if an emergency stop switch is actuated, if the drive is non-operational, or if the maximum wind speed for the operation of the cargo handler is exceeded.

The spring-action rail clamp 200 can thus be opened by virtue of the spring-action rail clamp being supplied with electrical power, and closed by virtue of the spring-action rail clamp being separated from the electrical power supply. This is easier than the implementation of the control of electric motor, electric valves and pressure switches of a spring-action rail clamp with a hydraulic assembly. Without hydraulics in the interior of the clamp, maintenance is also easier (no oil or filter changes, etc.), and there is also no risk of leakage of hydraulic oil and resulting contamination.

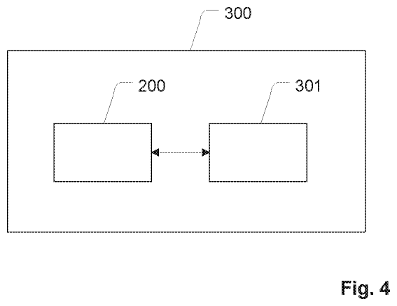

A control device (301 in FIG. 4) (integrated in an electronic circuit board) has the task of allowing the opening and closing of the rail clamp by virtue of the electric motor 201a and the electromagnetic brake 201b being controlled on the basis of the monitoring of the signals from the limit switches. In the event of a fault, the spring-action rail clamp and/or the control device can output an alarm.

The spring-action rail clamp 200 can be sold as a 100% electrical solution, because, although a small amount of damping fluid (oil) is used, this is situated in a sealed component.

Furthermore, possible faults can be identified and alarm signals output. If, for example, the spring-action rail clamp 200 is in the opened position and the control device is being supplied with electrical power, one possible fault may be a loss of the signal from the limit switch. As a result, the spring-action rail clamp 200 closes, and the control device outputs an alarm.

If the spring-action rail clamp 200 is opened, then the electric motor 201a runs, and if the time difference between two offset limit switches lies outside an expected value, the rail clamp closes and the control device outputs an alarm.

If the spring-action rail clamp 200 is opened, then the electric motor 201a runs, and if the limit switch for the opened position of the spring-action rail clamp 200 is then triggered before the safety switch, the spring-action rail clamp 200 closes again and the control device outputs an alarm.

The control device closes the spring-action rail clamp 200 and outputs an alarm if the running time of the electric motor 201a exceeds a maximum admissible time.

FIG. 4 shows an example of a cargo handler.

The cargo handler 300 comprises a control device 301 and a spring-action rail clamp 200, for example as described in FIG. 3.

The control device 301 controls the opening or disengagement, and closure, of the spring-action rail clamp 200. Here, the opening takes place only when the spring-action rail clamp 200 and control device 301 are in an energized state. Closure with a delay is also possible when the spring-action rail clamp 200 and the control device 301 are in a deenergized state.

The cargo handler 300 may be any cargo handler in which components or assemblies move along a rail. The cargo handler 300 is for example a gantry crane.

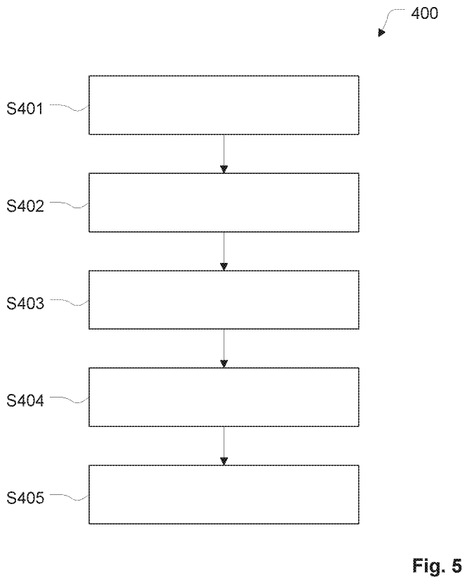

FIG. 5 shows a flow diagram of the closing process of the spring-action rail clamp.

The flow diagram 400 begins with step S401 in the deenergized state of the spring-action rail clamp, in which the spring-action rail clamp is closed and no signal is output by the limit switch.

In step S402, the control device is energized.

In step S403, the electric motor is activated. Said electric motor moves the spindle and, by means of the second yoke, compresses the springs, whilst the clamping jaws are opened.

In step S404, the limit switch outputs, to a control device of the cargo handler, a signal to the effect that the spring-action rail clamp has reached the opened position. This is the case for example because the second yoke has moved against the limit switch in the lower position.

In step S405, the electric motor is (simultaneously) deactivated, and the electromagnetic brake is activated; this state is maintained by the control device until such time as the control device is energized. The spring-action rail clamp is thus fixed in an opened position or disengagement position.

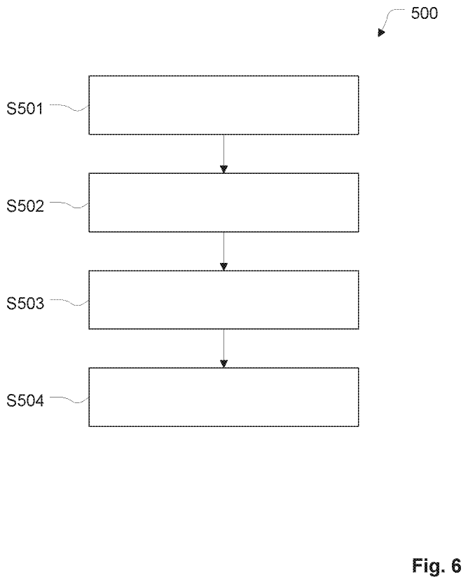

FIG. 6 shows a flow diagram of the closing process of the spring-action rail clamp.

The flow diagram 500 begins in step S501, in the state in which the control device is energized, the electric motor is deactivated and the electromagnetic brake is activated, wherein the spring-action rail clamp is in the opened position and the limit switches output a signal to the effect that the spring-action rail clamp is in the opened position.

In step S502, the control device is switched into a deenergized state, whereby the electromagnetic brake is deactivated.

In step S503, the spring-action rail clamp closes under the action of the spring force, with a delay owing to the closing delay system.

In step S504, the limit switches output, to a control device of the cargo handler, a signal to the effect that the spring-action rail clamp has departed from the opened position. The control device of the cargo handler then blocks movements of the cargo handler.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A closing delay system for a spring-action rail clamp having an electric motor, in particular as a storm brake of a cargo handler, the closing delay system comprising:
a tank having a damping fluid;
a pump that is driveable by the electric motor in order to convey the damping fluid bidirectionally;
a check valve that is arranged in a line section through which the damping fluid flows; and
a throttle that is arranged, in parallel with respect to the check valve, in the line section and through which the damping fluid flows such that the conveyed damping fluid is subjected to an increased flow resistance in a conveying direction through the line section equipped with the throttle, such that a time of engagement of the spring-action rail clamp is delayed.

2. The closing delay system according to claim 1, wherein the pump is arranged within the tank.

3. The closing delay system according to claim 1, wherein the pump comprises a gear pump.

4. The closing delay system according to claim 1, wherein the pump conveys the damping fluid from the tank through the line section and back into the tank when the electric motor drives the pump.

5. The closing delay system according to claim 1, wherein the tank comprises a tank casing and a flange.

6. The closing delay system according to claim 5, wherein the pump is installed on the flange of the tank.

7. The closing delay system according to claim 5, wherein the line section through which the damping fluid flows is formed in the flange.

8. A spring-action rail clamp comprising:
an electric motor; and
the closing delay system according to claim 1, which is driveable by the electric motor.

9. A controller to control the spring-action rail clamp according to claim 8.

10. A cargo handler comprising a closing delay system according to claim 1.
